(19) United States
(12) Patent Application Publication
(10) Pub. No.: US 2018/0323633 A1
(43) Pub. Date: Nov. 8, 2018

(54) RECEPTION DEVICE FOR WIRELESS CHARGING AND TERMINAL DEVICE

(71) Applicant: BEIJING SIGMA MICROELECTRONICS CO., LTD, Beijing (CN)

(72) Inventors: Bingjie CHEN, Beijing (CN); Zhiqian LI, Beijing (CN)

(73) Assignee: BEIJING SIGMA MICROELECTRONICS CO., LTD

(21) Appl. No.: 15/695,471

(22) Filed: Sep. 5, 2017

(30) Foreign Application Priority Data
May 4, 2017 (CN) 201710307848.2

(51) Int. Cl. H02J 7/02; H02J 50/10; H02J 50/80; H04B 5/00

(52) U.S. Cl. CPC H02J 7/025; H04B 5/0037; H02J 50/80; H02J 50/10

(57) ABSTRACT

The disclosure discloses a reception device for wireless charging and terminal device. The reception device for wireless charging includes: a coupling coil, arranged to acquire an alternating current signal; a rectifier tube, connected with the coupling coil and arranged to rectify the alternating current signal to obtain a charging current signal, wherein the charging current signal is used to charge a module to be charged; and a first Metal Oxide Semiconductor (MOS) transistor, connected with the rectifier tube and arranged to control switching-on or switching-off of a circuit between the rectifier tube and the module to be charged according to a coding value and transmit coding information corresponding to an on/off state of the circuit to a transmitter. According to the disclosure, the technical problem of complex circuit structure caused by full-bridge rectification adopted by a reception device for wireless charging in the related technology is solved.

### TECHNICAL FIELD OF THE DISCLOSURE

The embodiments of the disclosure relate to the field of electronics, and particularly to a reception device for wireless charging and a terminal device.

### BACKGROUND

At present, a rectification filtering process is required in a reception device for wireless charging in a wireless charging circuit to supply power to a load. Rectification in a reception device for wireless charging usually adopts full-bridge rectification in a related technology, and full-bridge rectification requires a relatively large number of components, so that the reception device for wireless charging is relatively complex in circuit structure, relatively large in size and inapplicable to a wireless charging circuit with a relatively small size.

For the problem of complex circuit structure caused by full-bridge rectification adopted by a reception device for wireless charging in the related technology, there is no effective solution yet.

### SUMMARY

Embodiments of the disclosure provide a reception device for wireless charging and a terminal device, so as to at least solve the technical problem of complex circuit structure caused by full-bridge rectification adopted by a reception device for wireless charging in the related technology.

According to one aspect of the embodiments of the disclosure, a reception device for wireless charging is provided, which includes: a coupling coil, arranged to acquire an alternating current signal; a rectifier tube, connected with the coupling coil and arranged to rectify the alternating current signal to obtain a charging current signal, wherein the charging current signal is used to charge a module to be charged; and a first Metal Oxide Semiconductor (MOS) transistor, connected with the rectifier tube and arranged to control switching-on or switching-off of a circuit between the rectifier tube and the module to be charged according to a coding value and transmit coding information corresponding to an on/off state of the circuit to a transmitter.

In an embodiment of the disclosure, the rectifier tube includes: a second MOS transistor, of which a first end is connected with the coupling coil and a second end is connected with the first MOS transistor, wherein the second MOS transistor is arranged to rectify the alternating current signal to obtain the charging current signal.

In an embodiment of the disclosure, the rectifier tube includes: a diode, of which the anode is connected with the coupling coil and the cathode is connected with the first MOS transistor, wherein the diode is arranged to rectify the alternating current signal to obtain the charging current signal.

In an embodiment of the disclosure, the reception device for wireless charging further includes: a controller, connected with the first MOS transistor and arranged to control switching-on or switching-off of the first MOS transistor.

In an embodiment of the disclosure, the controller is arranged to send a coding instruction to the first MOS transistor, wherein the coding instruction indicates to switch on or switch off the first MOS transistor.

In an embodiment of the disclosure, the coding instruction includes: at least one coding value, wherein the coding value indicates to switch on the first MOS transistor in a first predetermined time period and switch off the first MOS transistor in a second predetermined time period.

In an embodiment of the disclosure, the controller is further connected with the rectifier tube, and is arranged to control switching-on or switching-off of the rectifier tube.

In an embodiment of the disclosure, the reception device for wireless charging further includes: a capacitor, of which a first end is connected with the first MOS transistor and a second end is grounded, wherein the capacitor is arranged to filter the charging current signal.

According to another aspect of the embodiments of the disclosure, a terminal device is further provided, which includes any reception device for wireless charging in the embodiments of the disclosure.

In an embodiment of the disclosure, the reception device for wireless charging is arranged in the terminal device.

In the embodiments of the disclosure, an active half-bridge rectification manner is adopted, and half-bridge rectification is performed on an alternating current in the coupling coil by virtue of only one rectifier tube to rectify the alternating current signal into the charging current signal to charge the module to be charged. In addition, according to the embodiments of the disclosure, switching-on or switching-off control over a charging process may also be implemented by virtue of a MOS transistor, and coding communication with the transmitter is performed by virtue of the MOS transistor, so that a purpose of reducing a number of components in the reception device for wireless charging to simplify a circuit structure of the reception device for wireless charging is achieved, the technical problem of complex circuit structure caused by full-bridge rectification adopted by the reception device for wireless charging in the related technology is further solved, and a technical effect of optimizing the circuit structure of the reception device for wireless charging is further achieved.

### BRIEF DESCRIPTION OF THE DRAWINGS

The drawings described here are adopted to provide a further understanding to the disclosure, and form a part of the disclosure. Schematic embodiments of the disclosure and descriptions thereof are adopted to explain the disclosure and not intended to form improper limits to the disclosure. In the drawings:

FIG. 1 is an optional circuit diagram of a reception device for wireless charging according to an embodiment of the disclosure; and

FIG. 2 is another optional circuit diagram of a reception device for wireless charging according to an embodiment of the disclosure.

### DETAILED DESCRIPTION OF THE EMBODIMENTS

In order to make the solutions of the disclosure better understood by those skilled in the art, the technical solutions in the embodiments of the disclosure will be clearly and completely described below with reference to the drawings in the embodiments of the disclosure. Obviously, the described embodiments are not all embodiments but only part of embodiments of the disclosure. All other embodiments obtained by those skilled in the art on the basis of the embodiments in the disclosure without creative work shall fall within the scope of protection of the disclosure.

It should be noted that the terms “first”, “second” and the like in the Specification, claims and drawings of the disclosure are adopted to distinguish similar objects and are not required to be used for describing a specific sequence or an order. It should be understood that data used like that can be interchanged under a proper condition, so that the embodiments of the disclosure described here can be implemented in a sequence different from those shown or described here. In addition, terms “include” and “have” and any their deformation are intended to cover non-exclusive inclusion, for example, a process, method, system, product or equipment including a series of steps or units is not limited to the clearly listed steps or units, but may include other steps or units which are not clearly listed or are intrinsic for the process, method, product or equipment.

According to the embodiments of the disclosure, an embodiment of a reception device for wireless charging is provided. It is important to note that the reception device for wireless charging may be applied to a specific scenario where a module to be charged (such as equipment or module of a battery, a loudspeaker and the like) is wirelessly charged, and in the embodiment of the disclosure, specific descriptions are made with the condition that the module to be charged is a battery as an example.

It is important to note at first that a wireless charging system mainly performs energy coupling through coils to implement energy transmission by adopting an electromagnetic induction principle, an input end converts alternating current commercial power into a direct current through a rectifier circuit when the system works, or power is directly supplied to the system by virtue of a 24V direct current, a direct current output by a power management module is converted into a high-frequency alternating current for supply to a primary coil through a 2M active crystal oscillator inverter, energy is coupled through two induction coils, and a current output by a secondary coil is converted into a charging current signal to charge the battery through the reception device for wireless charging.

The reception device for wireless charging of the embodiment of the disclosure may include: a coupling coil, arranged to acquire an alternating current signal; a rectifier tube, connected with the coupling coil and arranged to rectify the alternating current signal to obtain a charging current signal, wherein the charging current signal may be arranged to charge a module to be charged, such as a battery; and a first MOS transistor, connected with the rectifier tube and arranged to control switching-on or switching-off of a circuit between the rectifier tube and the module to be charged according to a coding value and transmit coding information corresponding to an on/off state of the circuit to a transmitter.

For the components in the reception device for wireless charging, the following contents are required to be described.

First, there are no specific limits made to a model number of the coupling coil in the embodiment of the disclosure, and the coupling coil may include a primary coil and a secondary coil, wherein a high-frequency alternating current signal is supplied to the primary coil, energy is coupled through the two induction coils, and the secondary coil may acquire the alternating current signal. Inducing the energy through the coupling coil may realize a wireless charging function, and may further solve the problem of inconvenience for use caused by a requirement of charging equipment on a charging connecting wire.

Second, the rectifier tube may be connected with the secondary coil of the coupling coil, and may be arranged to rectify the alternating current signal in the secondary coil to obtain the charging current signal. As an optional embodiment, the alternating current signal is rectified by adopting only one rectifier tube component in the embodiment of the disclosure, so that a number of components in the reception device for wireless charging may be greatly reduced on the basis of achieving a rectification purpose, and an effect of simplifying a circuit structure of the reception device for wireless charging is further achieved.

It is important to note that there are no specific limits made to a type and model number of the rectifier tube. Optionally, the rectifier tube may be a rectifier diode, and may also be a synchronous rectification switching tube, such as a synchronous rectification MOS transistor. When the rectifier tube in the embodiment of the disclosure is a rectifier diode, the anode of the rectifier diode may be connected with the coupling coil, the cathode may be connected with the first MOS transistor, and a purpose of rectifying the alternating current signal of the coupling coil to obtain the charging current signal may be achieved by virtue of the rectifier diode. When the rectifier tube in the embodiment of the disclosure is a synchronous rectification MOS transistor, the synchronous rectification MOS transistor is called as a second MOS transistor here, a first end of the second MOS transistor may be connected with the coupling coil, a second end may be connected with the first MOS transistor, and the alternating current signal may also be rectified to obtain the charging current signal by virtue of the second MOS transistor. In the embodiment of the disclosure, active half-bridge rectification may be performed on the alternating current signal in the coupling coil to obtain the charging current signal by virtue of only one rectifier tube (such as a rectifier diode and a synchronous rectification MOS transistor).

Third, the charging current signal obtained by rectification of the rectifier tube may be arranged to charge the module to be charged, such as the battery, in the embodiment of the disclosure, wherein the battery to be charged may be an independent battery, and may also be a battery pack formed by multiple batteries. Or, the battery in the embodiment of the disclosure may also be a battery of terminal device to be charged, such as a battery of a mobile phone or a battery of a tablet computer. A positive end of the battery may be connected with the first MOS transistor, and a negative end of the battery may be grounded, so that the battery may be charged by virtue of the charging current signal output by the rectifier tube.

According to the reception device for wireless charging of the embodiment of the disclosure, an active half-bridge rectification manner is adopted, and half-bridge rectification is performed on an alternating current in the coupling coil by virtue of only one rectifier tube to rectify the alternating current signal into the charging current signal to charge the battery. A purpose of reducing the number of the components in the reception device for wireless charging to simplify the circuit structure of the reception device for wireless charging is achieved, and the technical problem of complex circuit structure caused by full-bridge rectification adopted by the reception device for wireless charging in the related technology is further solved, so that a technical effect of optimizing the circuit structure of the reception device for wireless charging is further achieved.

It is also important to note that the reception device for wireless charging may also realize a communication function in a wireless charging process, besides the wireless charging function, by additionally arranging a controller and the first MOS transistor in the reception device for wireless charging, wherein the first MOS transistor may be adopted for coding communication. The first MOS transistor and controller in the reception device for wireless charging will be introduced below in detail, specifically as follows.

The first MOS transistor in the embodiment may be connected with the rectifier tube, and the controller may be connected with the first MOS transistor. The controller may send a coding instruction to a communication control switch, and the first MOS transistor may control own on/off state to achieve a purpose of controlling switching-on or switching-off of a circuit between the rectifier tube and the module to be charged according to the coding instruction sent by the controller. It is important to note here that the circuit between the rectifier tube and the module to be charged may be additionally provided with a circuit module such as a Low Dropout Linear Regulator (LDO) and an Analogue Converter/Digital Converter (AC/DC), which will not be specifically described with examples one by one.

It is important to note that there are no specific limits made to a type and model number of the controller in the embodiment of the disclosure. For example, the controller may be a single-chip microcomputer, a programmable logic controller and the like. The coding instruction in the controller may be an instruction pre-edited according to a practical requirement, and the coding instruction is mainly used to indicate the first MOS transistor to control own on/off state. Optionally, the coding instruction may include one or more coding values, and these coding values may be arranged to indicate the on/off state of the first MOS transistor. Optionally, the coding values may indicate the first MOS transistor to be switched on in a first predetermined time period and switched off in a second predetermined time period, wherein the first predetermined time period and the second predetermined time period may be set or regulated according to a practical requirement, and will not be specifically limited herein. For example, the coding value “1” in the controller may correspond to “6-second switching-on and 3-second switching-off” of the first MOS transistor, and the coding value “0” may correspond to “3-second switching-on and 6-second switching-off” of the first MOS transistor. It is important to note here that the examples are not intended to limit that the coding instruction in the controller only includes the listed coding values but only to describe a specific function of the coding instruction in the controller, and the coding instruction may be set or regulated according to the practical requirement, and will not be described with examples one by one.

It is also important to note that there are no specific limits made to a model number of the first MOS transistor in the embodiment of the disclosure. Optionally, a first end of the first MOS transistor may be connected with the rectifier tube, a second end may be connected with the positive end of the battery to be charged, and a third end may be connected with the controller. The controller may send the coding instruction to the first MOS transistor, and the first MOS transistor may control own on/off state to implement control over the circuit between the rectifier tube and the battery to be charged to further achieve a purpose of controlling switching-on or switching-off of the wireless charging process according to the coding instruction of the controller.

Optionally, the first MOS transistor may also transmit coding information to the transmitter according to the on/off state of the circuit, besides controlling switching-on or switching-off of the circuit between the rectifier tube and the module to be charged according to the coding value sent by the controller, wherein the coding information may be indicated by the on/off state of the circuit. The transmitter may identify the coding information transmitted by the reception device for wireless charging according to the on/off state of the circuit to achieve a purpose of coding communication between the transmitter and the reception device for wireless charging.

Optionally, the controller in the embodiment may also be connected with the rectifier tube, and is arranged to control switching-on or switching-off of the rectifier tube. For example, when the rectifier tube is the second MOS transistor, the first end of the second MOS transistor may be connected with the coupling coil, the second end may be connected with the first end of the first MOS transistor, and a third end may be connected with the controller. Optionally, the controller may control switching-on or switching-off of the second MOS transistor according to a voltage of the second MOS transistor to achieve a purpose of further effectively controlling the wireless charging process.

It is important to note that: the controller is arranged and the controller is coded, so that the reception device for wireless charging of the embodiment may control switching-on or switching-off of the rectifier tube and switching-on or switching-off of the first MOS transistor, and the reception device for wireless charging of the embodiment may further realize a coding communication function on the basis of implementing wireless charging without increasing circuit complexity of the reception device for wireless charging.

As an optional embodiment, the reception device for wireless charging of the embodiment may further include a capacitor, a first end of the capacitor may be connected with the first MOS transistor and a second end is grounded, that is, the capacitor may be connected in parallel with the battery to be charged, and may be mainly arranged to filter the charging current signal obtained by rectification of the rectifier tube to further improve signal quality of the charging current signal and improve charging efficiency of the battery.

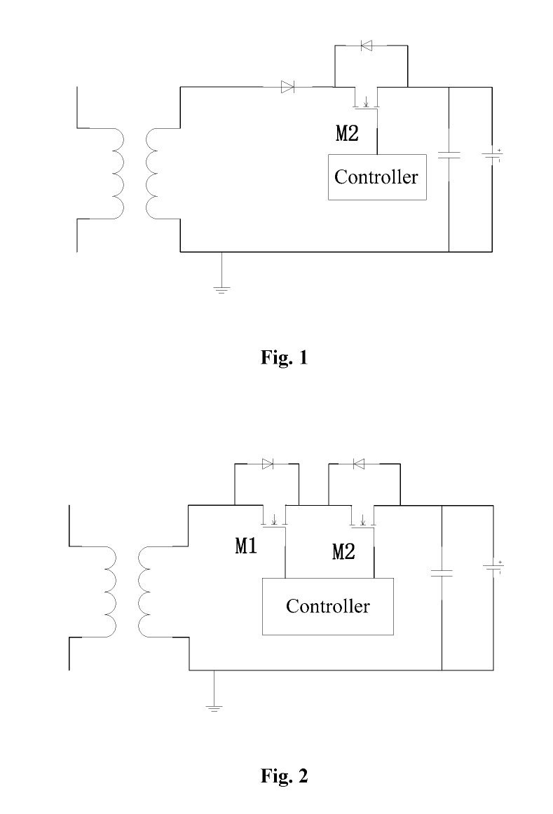

For different types of rectifier tubes in the reception device for wireless charging of the embodiment of the disclosure, the reception device for wireless charging of the embodiment of the disclosure may have two preferred circuit structures shown in FIG. 1 and FIG. 2. It is important to note that the two circuit structures shown in FIG. 1 and FIG. 2 are only two preferred circuit structures of the reception device for wireless charging of the embodiment of the disclosure, and are not intended to make a such limit that the reception device for wireless charging of the embodiment of the disclosure only includes the two circuit structures shown in FIG. 1 and FIG. 2. The reception device for wireless charging of the embodiment of the disclosure may further include other circuit structures, which will not be elaborated here one by one.

As an optional embodiment, FIG. 1 is an optional circuit diagram of a reception device for wireless charging according to an embodiment of the disclosure. As shown in FIG. 1, the reception device for wireless charging may include: a coupling coil, a rectifier diode, a MOS transistor M2, a capacitor and a battery, specifically as follows.

A secondary coil of the coupling coil may be connected with a rectifier tube, the rectifier tube shown in FIG. 1 may be a rectifier diode, the anode of the rectifier diode is connected with the secondary coil of the coupling coil, the cathode of the rectifier diode is connected with a first end of the MOS transistor M2 (the MOS transistor M2 in FIG. 1 is equivalent to the first MOS transistor in the embodiment of the disclosure, and may implement coding communication, a second end of the MOS transistor M2 may be connected with a positive end of the battery, a third end of the MOS transistor M2 may be connected with a controller, a negative end of the battery is grounded, and a filtering capacitor is connected in parallel with the two ends of the battery.

For the reception device for wireless charging shown in FIG. 1, an alternating current signal acquired by electromagnetic induction by the secondary coil of the coupling coil may be rectified into a charging current signal by the rectifier diode, and the charging current signal may be filtered by the capacitor to charge the battery. The controller may control an on/off state of the MOS transistor M2 according to a communication code to further control a wireless charging process of the battery. For example, the controller may send a communication code “1” to the MOS transistor M2, wherein the coding value “1” may correspond to “6-second switching-on and 3-second switching-off” of a communication control switch, and the MOS transistor M2 may execute “6-second switching-on and 3-second switching-off” to further avoid further influence on the charging process of the battery according to the coding value after receiving the communication code, that is, the controller may indirectly control 6-second charging, 3-second charging stopping and 6-second charging of the battery, and the charging process is sequentially repeated.

As another optional embodiment, FIG. 2 is another optional circuit diagram of a reception device for wireless charging according to an embodiment of the disclosure. As shown in FIG. 2, the reception device for wireless charging may include: a coupling coil, a MOS transistor M1, a MOS transistor M2, a capacitor and a battery, specifically as follows.

A secondary coil of the coupling coil may be connected with a first end of the MOS transistor M1 (the MOS transistor M1 in FIG. 2 is equivalent to the second MOS transistor in the embodiment of the disclosure, and may implement active half-bridge rectification), a second end of the MOS transistor M1 may be connected with a first end of the MOS transistor M2 (the MOS transistor M2 in FIG. 2 is equivalent to the first MOS transistor in the embodiment of the disclosure, and may implement coding communication), a second end of the MOS transistor M2 may be connected with a positive end of the battery, a third end of the MOS transistor M1 and a third end of the MOS transistor M2 may be connected with a controller, a negative end of the battery is grounded, and a filtering capacitor is connected in parallel with the two ends of the battery.

For the reception device for wireless charging shown in FIG. 2, an alternating current signal acquired by electromagnetic induction by the secondary coil of the coupling coil may be rectified into a charging current signal by the synchronous rectification MOS transistor M1, and the charging current signal may be filtered by the capacitor to charge the battery. The controller may control on/off states of the MOS transistor M1 and the MOS transistor M2 according to a communication code to further control a wireless charging process of the battery. For example, the controller may send a communication code “1” to the MOS transistor M2, wherein the coding value “1” may correspond to “6-second switching-on and 3-second switching-off” of a communication control switch, and the MOS transistor M2 may execute “6-second switching-on and 3-second switching-off” to further avoid further influence on the charging process of the battery according to the coding value after receiving the communication code, that is, the controller may indirectly control 6-second charging, 3-second charging stopping and 6-second charging of the battery, and the charging process is sequentially repeated. The controller may also control switching-on or switching-off of the MOS transistor M1 according to a voltage of the MOS transistor M1 to achieve a purpose of further controlling the wireless charging process. It is important to note that the reception device for wireless charging shown in FIG. 2 adopts the synchronous rectification MOS transistor instead of the diode in the reception device for wireless charging shown in FIG. 1, so that more stable rectification performance may be achieved, and in a practical application scenario. A user may select any one for rectification according to a practical requirement.

It is important to note that the reception device for wireless charging in the embodiment of the disclosure adopts an active half-bridge rectifier circuit, and besides the controller, only two MOS transistors and a capacitor or only one MOS transistor, a diode and a capacitor may be required to complete the wireless charging process. Moreover, one MOS transistor in the reception device for wireless charging in the embodiment of the disclosure may also be adopted for coding communication, so that the communication function may be realized in the wireless charging process under the condition of not increasing the number of the components and the circuit complexity.

The reception device for wireless charging in the embodiment of the disclosure adopts relatively few components, is simple in structure, and may perform coding communication, so that functions are added, and the components in the circuit are also reduced.

According to the embodiments of the disclosure, an embodiment of terminal device is further provided. It is important to note that there are no specific limits made to a type of the terminal device in the embodiment of the disclosure. For example, the terminal device may include, but not limited to, a mobile phone, a tablet computer and the like. It is also important to note that the terminal device may include any reception device for wireless charging in the embodiment of the disclosure. The reception device for wireless charging has been specifically introduced in the abovementioned embodiment of the disclosure, and will not be elaborated herein. Optionally, any reception device for wireless charging in the embodiment of the disclosure may be arranged in the terminal device, so that the terminal device may be wirelessly charged through the reception device for wireless charging.

The sequence numbers in the embodiments of the disclosure are adopted for description only, and do not represent the superiority-inferiority of the embodiments.

In the embodiments of the disclosure, extra emphasis is placed on the description of each embodiment, and for parts not described in detail in certain embodiments, see related description in the other embodiments.

From the embodiments provided by the disclosure, it should be understood that the disclosed technical contents may be implemented in other manners. Wherein, the device embodiment described above is only schematic, for example, division of the units may be logic function division, and there are other division manners during practical implementation, for example, multiple units or components can be combined or integrated to another system, or some characteristics can be neglected, or not executed. In addition, the displayed or discussed mutual coupling or direct coupling or communication connection may be indirect coupling or communication connection implemented through some interfaces, units or modules, and may be implemented electrically or in other forms.

The units described as separate parts may be or may not be physically separated, and the parts displayed as units may be or may not be physical units, that is, the parts may be positioned at the same place, or may be distributed on multiple units. A part or all of the units can be selected to fulfill the aims of the solutions of the embodiments according to actual needs.

In addition, each functional unit in each embodiment of the disclosure may be integrated in a processing unit, and may independently and physically exist, and two or more than two units are integrated in a unit. The integrated units may be implemented in a form of hardware, and may also be implemented in form of software functional unit.

If the integrated units are implemented in form of software function unit and sold or used as independent products, the integrated units may be stored in a computer-readable storage medium. Based on such understanding, the technical solutions of the disclosure may substantially be or the parts making contributions to the existing technology or all or a part of the technical solutions may be embodied in form of software product, and the computer software product is stored in a storage medium, and includes a plurality of instructions for making a piece of computer equipment (which may be a personal computer, a server, network equipment or the like) execute all or a part of steps of the method in each embodiment of the disclosure. The storage medium includes: various media capable of storing program codes such as a U disk, a Read-Only Memory (ROM), a Random Access Memory (RAM), a mobile hard disk, a disk or a compact disc.

The above is only the preferred implementation mode of the disclosure, and it should be pointed out that those skilled in the art may make a plurality of improvements and embellishments without departing from the principle of the disclosure, and the improvements and embellishments shall be considered within the scope of protection of the disclosure.

What is claimed is:

1. A reception device for wireless charging, comprising:
a coupling coil, arranged to acquire an alternating current signal;
a rectifier tube, connected with the coupling coil and arranged to rectify the alternating current signal to obtain a charging current signal, wherein the charging current signal is used to charge a module to be charged; and
a first Metal Oxide Semiconductor (MOS) transistor, connected with the rectifier tube and arranged to control switching-on or switching-off of a circuit between the rectifier tube and the module to be charged according to a coding value and transmit coding information corresponding to an on/off state of the circuit to a transmitter.

2. The reception device for wireless charging as claimed in claim 1, wherein the rectifier tube comprises:
a second MOS transistor, of which a first end is connected with the coupling coil and a second end is connected with the first MOS transistor, wherein the second MOS transistor is arranged to rectify the alternating current signal to obtain the charging current signal.

3. The reception device for wireless charging as claimed in claim 1, wherein the rectifier tube comprises:
a diode, of which the anode is connected with the coupling coil and the cathode is connected with the first MOS transistor, wherein the diode is arranged to rectify the alternating current signal to obtain the charging current signal.

4. The reception device for wireless charging as claimed in claim 1, further comprising:
a controller, connected with the first MOS transistor and arranged to control switching-on or switching-off of the first MOS transistor.

5. The reception device for wireless charging as claimed in claim 4, wherein the controller is arranged to send a coding instruction to the first MOS transistor, wherein the coding instruction indicates to switch on or switch off the first MOS transistor.

6. The reception device for wireless charging as claimed in claim 5, wherein the coding instruction comprises:
at least one coding value, wherein the coding value indicates to switch on the first MOS transistor in a first predetermined time period and switch off the first MOS transistor in a second predetermined time period.

7. The reception device for wireless charging as claimed in claim 4, wherein the controller is further connected with the rectifier tube, and is arranged to control switching-on or switching-off of the rectifier tube.

8. The reception device for wireless charging as claimed in claim 1, further comprising:
a capacitor, of which a first end is connected with the first MOS transistor and a second end is grounded, wherein the capacitor is arranged to filter the charging current signal.

9. A terminal device, comprising the reception device for wireless charging as claimed in claim 1.

10. The terminal device according to claim 9, wherein the reception device for wireless charging is arranged in the terminal device.

11. The reception device for wireless charging as claimed in claim 2, further comprising:
a controller, connected with the first MOS transistor and arranged to control switching-on or switching-off of the first MOS transistor.

12. The reception device for wireless charging as claimed in claim 3, further comprising:
a controller, connected with the first MOS transistor and arranged to control switching-on or switching-off of the first MOS transistor.

13. The reception device for wireless charging as claimed in claim 2, further comprising:
a capacitor, of which a first end is connected with the first MOS transistor and a second end is grounded, wherein the capacitor is arranged to filter the charging current signal.

14. The reception device for wireless charging as claimed in claim 3, further comprising:
a capacitor, of which a first end is connected with the first MOS transistor and a second end is grounded, wherein the capacitor is arranged to filter the charging current signal.

15. A terminal device, comprising the reception device for wireless charging as claimed in claim 2.

16. A terminal device, comprising the reception device for wireless charging as claimed in claim 3.

17. A terminal device, comprising the reception device for wireless charging as claimed in claim 4.

18. A terminal device, comprising the reception device for wireless charging as claimed in claim 5.

19. A terminal device, comprising the reception device for wireless charging as claimed in claim 6.

20. A terminal device, comprising the reception device for wireless charging as claimed in claim 7.
